(19) United States
(12) Patent Application Publication
(10) Pub. No.: US 2022/0077487 A1
(43) Pub. Date: Mar. 10, 2022

(54) FUEL CELL VEHICLE

(71) Applicant: TOYOTA JIDOSHA KABUSHIKI KAISHA, Toyota-shi (JP)

(72) Inventors: Yugo ICHIDA, Seto-shi (JP); Masayuki ITO, Sunto-gun (JP); Yoshihiro SHINOZAKI, Atsugi-shi (JP)

(73) Assignee: TOYOTA JIDOSHA KABUSHIKI KAISHA, Toyota-shi (JP)

(21) Appl. No.: 17/445,149

(22) Filed: Aug. 16, 2021

(30) Foreign Application Priority Data
Sep. 7, 2020 (JP) 2020-149842

(51) Int. Cl. H01M 8/2475; H01M 8/2485

(52) U.S. Cl. CPC H01M 8/2475; H01M 2250/20; H01M 8/2485

(57) ABSTRACT

A fuel cell vehicle includes a fuel cell stack including a stack case as a housing in which a plurality of fuel cells is accommodated and a plate-shaped end plate configured to close an opening of the stack case. The end plate has an overhanging portion configured to overhang from a part, of the stack case, in which the fuel cells are accommodated. The fuel cell stack is placed in a front room or a rear room. The height position of at least part of the overhanging portion is the same as the height position of a frame of the fuel cell vehicle.

### CROSS-REFERENCE TO RELATED APPLICATION

This application claims priority to Japanese Patent Application No. 2020-149842 filed on Sep. 7, 2020, incorporated herein by reference in its entirety.

### BACKGROUND

### 1. Technical Field

This disclosure relates to a fuel cell vehicle.

### 2. Description of Related Art

Along with downsizing of a fuel cell stack, it is considered to provide a fuel cell stack in a front room (a motor room) of a vehicle. At this time, a plurality of power generation cells (fuel cells) provided in the fuel cell stack is provided in a vertically stacked state. Japanese Unexamined Patent Application Publication No. 2011-051379 (JP 2011-051379 A) describes a vehicle in which a fuel cell unit is placed in a front room formed in front of a dash board. The fuel cell unit includes a fuel cell stack in which a plurality of fuel cells is stacked. In the vehicle, the fuel cells are stacked in the up-down direction.

### SUMMARY

In JP 2011-051379 A, a front bumper frame is placed at the same height as a fuel cell part in the fuel cell stack. Accordingly, the vehicle has such a structure that, when a front part of the vehicle collides with an obstacle, it is highly likely that the front bumper frame moves rearward, so that the front bumper frame or a member placed in the front room collides with the fuel cells. When the fuel cells collide with such members, the fuel cells thus stacked deviate from each other, so that sealing performance may decrease or power generation performance may decrease.

This disclosure provides a vehicle that can increase protection performance for fuel cells.

The present application describes a fuel cell vehicle. The fuel cell vehicle includes a fuel cell stack including a stack case as a housing in which a plurality of fuel cells is accommodated and a plate-shaped end plate configured to close an opening of the stack case. The end plate has an overhanging portion configured to overhang from a part, of the stack case, in which the fuel cells are accommodated. The fuel cell stack is placed in a front room or a rear room. The height position of at least part of the overhanging portion is the same as the height position of a frame of the fuel cell vehicle.

A member may be placed on an outer surface of the fuel cell stack. The member may be placed on a surface of the fuel cell stack, the surface being on an opposite side of the fuel cell stack from the frame.

An overhanging amount of the overhanging portion may be partially changed.

In the fuel cell vehicle, the frame may be at least one of a front bumper frame, a side frame, and a rear bumper frame.

With the fuel cell vehicle according to this disclosure, it is possible to increase protection performance for fuel cells even at the time of a collision.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view to describe a vehicle 10 according to a first embodiment and illustrates the vehicle 10 viewed from its lateral side;

FIG. 2 is a schematic view to describe the vehicle 10 according to the first embodiment and illustrates the vehicle 10 viewed from its front side;

FIG. 3 is a perspective view of the appearance of a fuel cell stack 21;

FIG. 4 is a view to describe the relationship between the fuel cell stack 21 and a front bumper frame 15;

FIG. 5 is a schematic view to describe a vehicle 10′ according to a second embodiment and illustrates the vehicle 10′ viewed from its lateral side; and

FIG. 6 is a schematic view to describe a vehicle 10″ according to a third embodiment and illustrates the vehicle 10″ viewed from its lateral side.

### DETAILED DESCRIPTION OF EMBODIMENTS

### First Embodiment

1. Structure of Vehicle

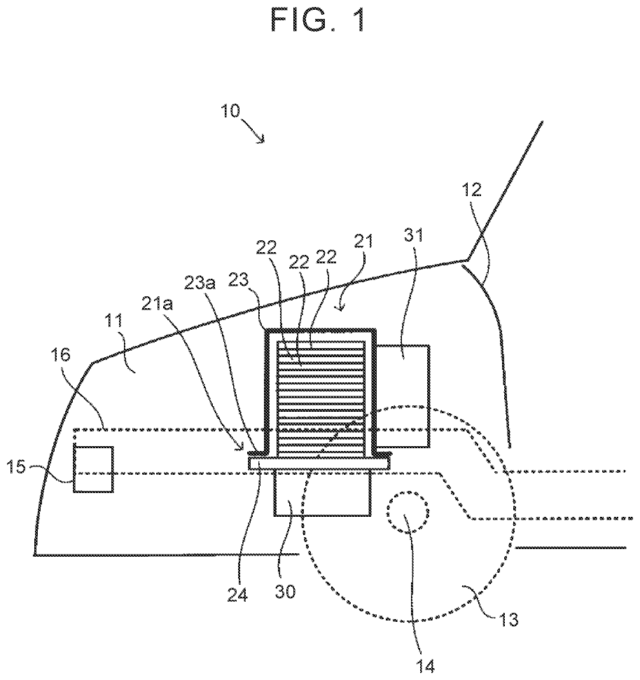

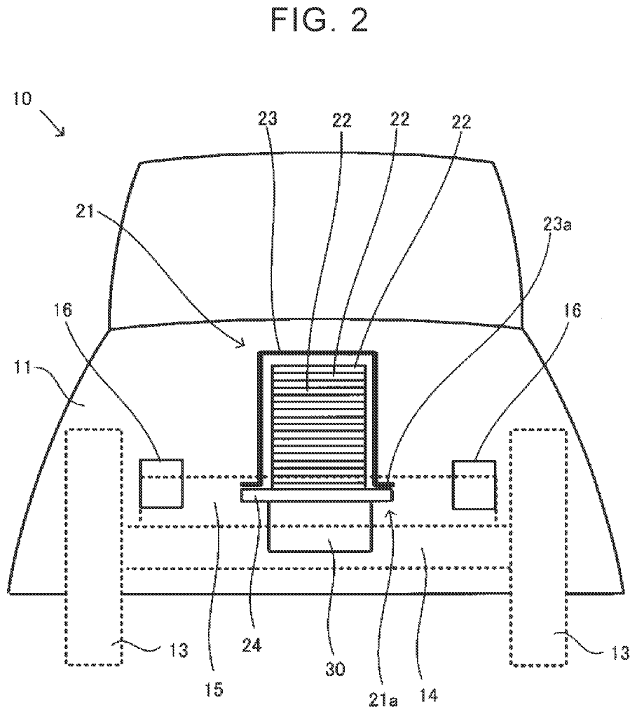

As well known, a vehicle is constituted by combining many members, and a vehicle according to the present embodiment can also include well-known members except what is described below. Accordingly, descriptions of the well-known members are omitted. The following describes necessary points. FIGS. 1, 2 are views to describe the inside of a front room 11 in a vehicle 10 according to a first embodiment. FIG. 1 is a view of the vehicle 10 viewed from its lateral side, and the left side on the plane of paper is a forward direction. Further, FIG. 2 is a view of the vehicle 10 viewed from its front side. As well known, the front room 11 is a space formed in front of a dash panel 12, and various devices for driving the vehicle are stored in the front room 11. Further, in FIGS. 1, 2, a front wheel 13 and a front drive shaft 14 are indicated by dotted lines. The vehicle 10 in the present embodiment further includes the following constituent components.

1.1. Front Bumper Frame

A front bumper frame 15 is one of members constituting a frame of a vehicle body and is a frame provided in a front end part of the vehicle body. The front bumper frame 15 has a shock absorber function. Accordingly, as can be seen from FIGS. 1, 2, the front bumper frame 15 is a frame provided in a front end part of the front room 11 and extending in the right-left direction of the front room 11 (the vehicle 10).

Such a front bumper frame 15 may be a well-known frame and is not limited in particular.

1.2. Side Frame

A side frame 16 is one of members constituting the frame of the vehicle body and is a frame provided in each of right and left side parts. Accordingly, as can be seen from FIGS. 1, 2, the side frame 16 is a frame placed in each of the right and left side parts of the vehicle 10 and extending in the vehicle front-rear direction.

Such a side frame 16 may be a well-known frame and is not limited in particular.

1.3. Fuel Cell System

A fuel cell system includes a fuel cell stack 21, an accessory unit 30, a converter 31, a hydrogen tank, and an air acquisition unit. Hereby, hydrogen is supplied to the fuel cell stack 21 from the hydrogen tank through a hydrogen supply pipe, and air is supplied to the fuel cell stack 21 from the air acquisition unit. Electric power is generated by the fuel cell stack 21 to which the hydrogen and the air are supplied, and an electric motor placed in the front room 11 is driven by the electric power thus generated. In FIGS. 1, 2, the fuel cell stack 21, the accessory unit 30, and the converter 31 in the fuel cell system are illustrated, and other members are not illustrated. Well-known members can be used for these other members. The following describes the members illustrated herein.

1.3a. Fuel Cell Stack

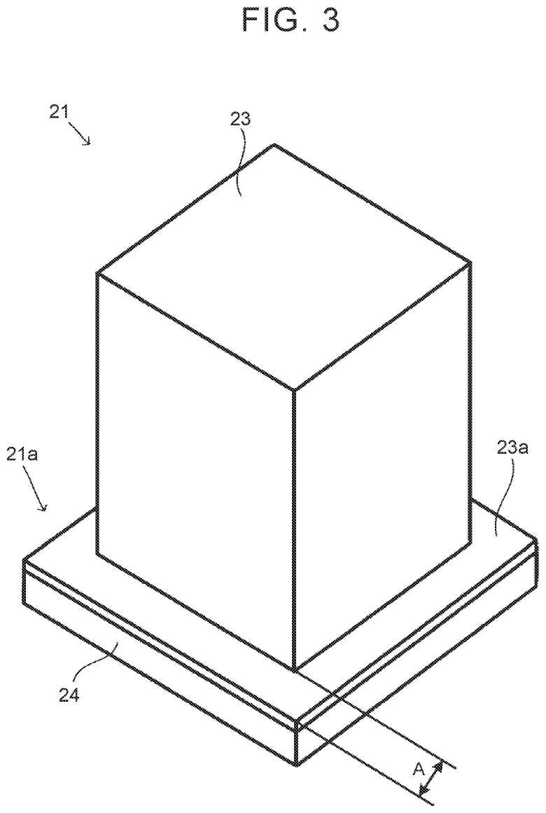

FIG. 3 is a perspective view of the appearance of the fuel cell stack 21. As can be seen from FIGS. 1 to 3, the fuel cell stack 21 includes fuel cells 22, a stack case 23, and an end plate 24.

The fuel cell 22 is a well-known fuel cell and is configured such that a membrane electrode assembly (MEA) is sandwiched between two separators. The MEA is a laminated body constituted by a solid polymer membrane, a negative-electrode catalyst layer, a positive-electrode catalyst layer, a negative-electrode gas diffusion layer, a positive-electrode gas diffusion layer, and so on. The fuel cell stack 21 is configured such that a plurality of fuel cells 22 configured as such is stacked.

The stack case 23 is a housing in which the fuel cells 22 thus stacked are accommodated. In the present embodiment, the stack case 23 is a rectangular-solid housing. A wall portion is not provided on one surface of the stack case 23 so that an opening is formed. A flange 23a is formed along the edge of the opening such that a plate-shaped piece overhangs toward sides opposite to the opening. The fuel cells 22 are accommodated inside the stack case 23 through the opening. This opening opens on lower side of the vehicle. From the viewpoint that the stack case 23 has a function to protect the fuel cells 22 from outside, it is preferable that the stack case 23 have a predetermined strength and be made of metal with a thickness of around 3 mm. Further, the overhanging amount A of the flange 23a indicated in FIG. 3 is not limited in particular. However, from the viewpoint that the stack case 23 is joined to the end plate 24 via the flange 23a with bolts and nuts or the like and water cut-off performance is obtained, it is preferable that the flange 23a have an overhanging amount to some extent. From those viewpoints, it is preferable that the overhanging amount be 10 mm or more.

The end plate 24 is a plate-shaped member and is placed to close the opening of the stack case 23 and to overlap with the flange 23a of the stack case 23. For example, the end plate 24 is fixed to the stack case 23 by bolts and nuts or the like placed to penetrate through the flange 23a and the end plate 24 so that the end plate 24 closes the stack case 23. Hereby, an overhanging portion 21a overhanging from a part, of the stack case 23, in which the fuel cells 22 are accommodated is formed in a part where the flange 23a and the end plate 24 overlap each other. The end plate 24 functions as a cover for the stack case 23 and gives strength to the overhanging portion 21a as will be describe later. In view of this, it is preferable that the end plate 24 have a high strength. On this account, it is preferable that the end plate 24 be made of metal and have a plate thickness that is thicker than at least the plate thickness of walls constituting the stack case 23 and the plate thickness of the flange 23a. More preferably, the thickness of the end plate 24 is 20 mm or more. In the present embodiment, the end surface of the flange 23a and the end surface of the end plate 24 are placed at the same position, but they are not limited to this. The end surface of the end plate 24 may overhang from the end surface of the flange 23a.

1.3b. Accessory Unit

The accessory unit 30 is a unit including a reactant gas supply-circulation device, a coolant supply-circulation device, and so on. In the present embodiment, the accessory unit 30 is attached to a surface of the end plate 24, the surface being opposite to a surface, of the end plate 24, on which the stack case 23 is placed.

1.3c. Converter

The converter 31 is a member having a function to boost the output voltage of the fuel cell stack 21, and a well-known converter can be employed. In the present embodiment, the converter 31 is attached to an outer surface of the part, of the stack case 23, in which the fuel cells 22 are accommodated, among outer surfaces of the stack case 23.

1.4. Arrangement of Fuel Cell Stack and so on

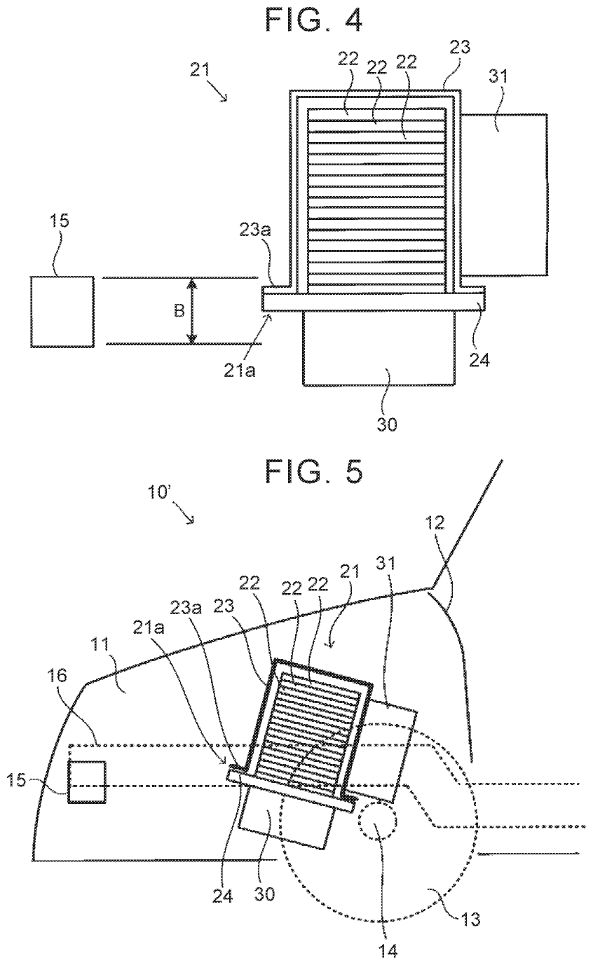

In the present embodiment, it is preferable that the fuel cell stack 21 be placed in the front room 11 as follows. FIG. 4 is an enlarged view focusing on the front bumper frame 15 and the fuel cell stack 21 from FIG. 1 and describes their arrangement and positional relationship. As can be seen from FIGS. 1, 2, 4, the fuel cell stack 21 is arranged such that the end plate 24 is placed on the lower side of the fuel cell stack 21 and the fuel cells 22 are stacked in the up-down direction.

The accessory unit 30 and the converter 31 are placed on surfaces of the fuel cell stack 21 on sides where the front bumper frame 15 and the side frames 16 are not provided. That is, in the present embodiment, the converter 31 is placed on a surface of the fuel cell stack 21, the surface being on the opposite side of the fuel cell stack 21 from the front bumper frame 15. The accessory unit 30 is placed on the lower surface of the fuel cell stack 21. The description made herein deals with an example in which the accessory unit and the converter are provided as members placed on the outer surfaces of the fuel cell stack. However, the present embodiment is not limited to this, and the members placed on the outer surfaces of the fuel cell stack 21 are thus placed on the surfaces of the fuel cell stack 21 on the sides where the front bumper frame 15 and the side frames 16 are not provided.

As can be seen from FIGS. 1, 4, in terms of the overhanging portion 21a of the fuel cell stack 21, a part of the overhanging portion 21a the overhanging direction of which faces the front bumper frame 15 is at least partially placed at a height position falling within a height-position range (a height position within a range indicated by B in FIG. 4) where the front bumper frame 15 is present. It is preferable that the part of the overhanging portion 21a the overhanging direction of which faces the front bumper frame 15 be fully placed at the height position falling within the range indicated by B.

Similarly, as can be seen from FIG. 2, in terms of the overhanging portion 21a of the fuel cell stack 21, a part of the overhanging portion 21a the overhanging direction of which faces the side frame 16 is at least partially placed at a height position falling within a height-position range where the side frame 16 is present. It is preferable that the part of the overhanging portion 21a the overhanging direction of which faces the side frame 16 be fully placed at the height position falling within the range.

2. Effects

The vehicle having the above configuration operates as follows.

Relationship with Front Bumper Frame

When the vehicle 10 collides with an obstacle ahead of the vehicle 10, the front bumper frame 15 moves rearward relative to a vehicle cabin, so that the side frames 16 partially contract. Hereby, the impact caused by the collision is absorbed, so that the space of the vehicle cabin is maintained and protected. Here, in a case where the amount of rearward movement of the front bumper frame due to the collision is large, the front bumper frame or a member placed between the front bumper frame and the fuel cell stack may hit the fuel cell stack. In a case where such a member directly hits a part, of the stack case, in which the fuel cells are accommodated or such a member directly hits the fuel cells, the stack case might be partially damaged, and the stacked fuel cells might deviate from each other. In a case where the fuel cells deviate from each other, sealing performance between the cells may decrease, or power generation performance may decrease because an appropriate contact pressure is not applied to the fuel cells. In this respect, in the present embodiment, the overhanging portion 21a of the fuel cell stack 21 is positioned within the height-position range where the front bumper frame 15 is present. Accordingly, when the front bumper frame 15 moves rearward, the front bumper frame 15 first hits the overhanging portion 21a. Since the overhanging portion 21a has a high rigidity as described above, the overhanging portion 21a is not damaged promptly even when the front bumper frame 15 hits the overhanging portion 21a. Further, since the overhanging portion 21a projects forward in the vehicle front-rear direction from the fuel cells 22, the front bumper frame 15 surely hits the overhanging portion 21a earlier than the part in which the fuel cells 22 are placed, so that the overhanging portion 21a can receive a load. Accordingly, in this configuration, the fuel cell stack 21 is hardly damaged even at the time of a collision of the vehicle 10, so that the fuel cell stack 21 is more likely to be usable continuously even after the collision.

Relationship with Side Frames

The relationship between the side frame 16 and the fuel cell stack 21 can be considered in a similar manner to the relationship between the front bumper frame 15 and the fuel cell stack 21. In this case, when another vehicle collides with the front room 11 of the vehicle 10 from the lateral side of the vehicle 10, for example, and the side frame 16 enters the front room 11 and hits the fuel cell stack 21, a load can be received by the overhanging portion 21a having a high rigidity, so that the fuel cell stack 21 can be hardly damaged.

Member Placed on Outer Surface of Fuel Cell Stack

In the present embodiment, the accessory unit 30 is placed on the lower surface of the fuel cell stack 21, and the converter 31 is placed on the rear side of the fuel cell stack 21 in the vehicle front-rear direction (that is, the opposite side of the fuel cell stack 21 from the front bumper frame 15). Accordingly, the front drive shaft 14 is placed behind the accessory unit 30 and below the converter 31 such that the front drive shaft 14 penetrates the vehicle 10 in the right-left direction. This layout allows these members to be accommodated in the front room 11 of the vehicle 10 with a high space efficiency. Further, due to such an arrangement of the accessory unit 30 and the converter 31, the accessory unit 30 and the converter 31 are less likely to hit the front bumper frame 15, the side frames 16, and so on at the time of a collision, thereby making it possible to secure the safety of hydrogen and the security of high voltage at the time of the collision.

3. Others

In the present embodiment, the overhanging portion 21a has the same overhanging amount at all the portions of the overhanging portion 21a. However, the present disclosure is not limited to this, and the overhanging amount of the overhanging portion 21a may be partially changed. For example, parts of the overhanging portion 21a the overhanging directions of which face the front bumper frame 15 and the side frames 16 may have overhanging amounts larger than the overhanging amounts of other parts of the overhanging portion 21a. This can markedly yield the above effects.

### Second Embodiment

FIG. 5 is a view to describe a vehicle 10′ according to a second embodiment. FIG. 5 is a view corresponding to FIG. 1. As can be seen from FIG. 5, the vehicle 10′ is different from the vehicle 10 in that the upper side of the fuel cell stack 21 is placed rearward and inclined so that the overhanging portion 21a side is placed forward. Other configurations can be considered to be similar to those in the vehicle 10 according to the first embodiment. Accordingly, the same reference signs as the first embodiment are assigned to equivalent constituents, and descriptions thereof are omitted. Generally, the upper surface of the front room 11 is lower on its front side and higher on its rear side. Since the vehicle 10′ is configured such that the fuel cell stack 21 is inclined, an upper part of the fuel cell stack 21 can be positioned rearward. Accordingly, even in a case where the height of the front room 11 is low, the fuel cell stack 21 can be provided. Further, since a lower part of the fuel cell stack 21 is placed forward in the vehicle front-rear direction, it is easy to secure a distance from the front drive shaft 14, thereby making it possible to further easily place the fuel cell stack 21 in the front room 11.

### Third Embodiment

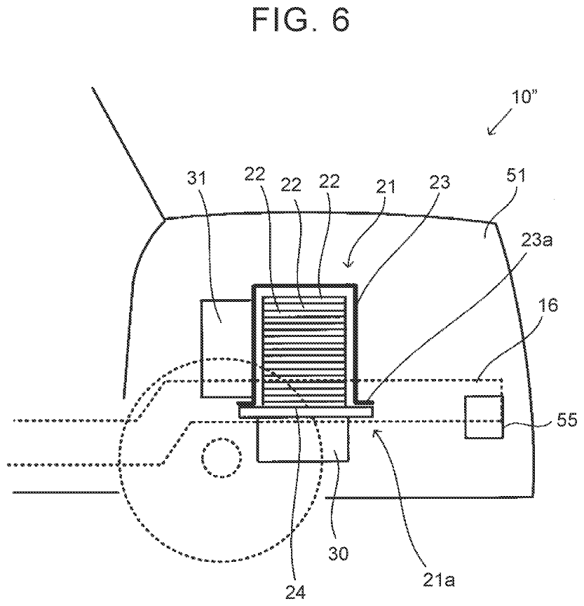

FIG. 6 is a view to describe a vehicle 10″ according to a third embodiment. FIG. 6 is a view corresponding to FIG. 1. In the vehicle 10″, the fuel cell stack 21 is accommodated in a rear room 51 placed behind the vehicle cabin of the vehicle 10″. In the vehicle 10″, the fuel cell stack 21 should be also placed similarly to the idea of the vehicle 10 in the first embodiment. At this time, a rear bumper frame 55 as one of members constituting the frame of the vehicle body is assumed instead of the front bumper frame 15, and a rear-end collision from the rear side is assumed instead of a front collision in the first embodiment. That is, when the vehicle 10″ has a rear-end collision from the rear side, the rear bumper frame 55 moves forward relative to the vehicle cabin, so that the side frames 16 partially contract. Hereby, the impact caused by the collision is absorbed, so that the space of the vehicle cabin is maintained and protected. Even in this configuration, the rear bumper frame 55 or a member placed between the rear bumper frame 55 and the fuel cell stack 21 first hits the overhanging portion 21a of the fuel cell stack 21 at the time of a collision. Hereby, the same effect as above can be yielded.

What is claimed is:

1. A fuel cell vehicle, comprising:
a fuel cell stack including a stack case as a housing in which a plurality of fuel cells is accommodated and a plate-shaped end plate configured to close an opening of the stack case, wherein:
the end plate has an overhanging portion configured to overhang from a part, of the stack case, in which the fuel cells are accommodated;
the fuel cell stack is placed in a front room or a rear room; and
a height position of at least part of the overhanging portion is the same as a height position of a frame of the fuel cell vehicle.

2. The fuel cell vehicle according to claim 1, wherein:
a member is placed on an outer surface of the fuel cell stack; and
the member is placed on a surface of the fuel cell stack, the surface being on an opposite side of the fuel cell stack from the frame.

3. The fuel cell vehicle according to claim 2, wherein:
the member is an accessory unit or a converter.

4. The fuel cell vehicle according to claim 1, wherein an overhanging amount of the overhanging portion is partially changed.

5. The fuel cell vehicle according to claim 4, wherein an overhanging amount of a part of the overhanging portion which overhangs towards the frame is larger than an overhanging amount of a part of the overhanging portion which does not overhang towards the frame.

6. The fuel cell vehicle according to claim 1, wherein the frame is at least one of a front bumper frame, a side frame, and a rear bumper frame.

7. The fuel cell vehicle according to claim 1, wherein
the plurality of fuel cells are stacked in a height direction of the fuel cell vehicle.

8. The fuel cell vehicle according to claim 1, wherein
the opening the stack case opens on a lower side of the fuel cell vehicle.
